(19) United States
(12) Patent Application Publication
(10) Pub. No.: US 2006/0114893 A1
(43) Pub. Date: Jun. 1, 2006

(54) Updating associating data in a media device

(76) Inventors: Timo Tokkonen, Oulu (FI); Helena Tokkonen, Oulu (FI); Juha P. Matero, Oulu (FI)

Correspondence Address: Hollingsworth & Funk, LLC, Suite 125, 8009 34h Avenue South, Minneapolis, MN, 55425, US

(21) Appl. No.: 10/999,069

(22) Filed: Nov. 29, 2004

(51) Int. Cl. H04L 12/56; H04L 12/28; H04Q 7/24

(52) U.S. Cl. 370/389; 370/338

(57) ABSTRACT

A media device and a method of updating associating data in a media device are provided. The associating data relates to a service being transmitted over a radio interface of a cellular telecommunication system and associating the service with a broadcast media stream transmitted by a broadcast system. A starting point of a route of the media device is determined. A geographical route from the starting point to a point of destination is determined, the route comprising a set of locations. A selection of a location from the set of locations is received. The associating data related to the service and a broadcast media stream transmitted to the geographical area in the vicinity of the selected location is determined. The broadcast media stream and the service associated with the media stream are received.

### FIELD

The invention relates to updating associating data in a media device. Especially the invention relates to media devices configured to receive a broadcast media stream from a broadcast system.

### BACKGROUND

Broadcasters, such as television and radio broadcasters, have taken steps forward to provide an audience with digital supplementary services, such as program information, news, weather information, competitions and other related content, in addition to a traditional media stream. The digital supplementary services are usually delivered to the audience over the Internet using the audience's personal computers or other media devices capable of connecting to the Internet.

More mobility is provided for the audience by media devices of cellular telecommunication systems, which media devices are equipped with a receiver, such as an FM radio, for receiving media streams broadcast by broadcasters. Broadcasters typically provide Internet services, which can be accessed by media devices, such as the one equipped with a WAP (Wireless Application Protocol), capable of connecting to such a service. In order to obtain the service needed, the user is required to navigate to the broadcaster's Internet site, select the right service and download suitable data which enables the user's media device to receive the service. In order to inform the users about services available, the broadcasters usually promote their Internet address in actual television or radio broadcasts, or in other mass media.

There are, however, problems related to complexity in accessing a service by a user. The complexity arises from a need for advertising service addresses by the broadcasters and memorizing desired service addresses by the user. Furthermore, navigating a way through a complicated Internet web structure to the correct service address is laborious and time consuming. The complexity in accessing the service results in a high barrier for a user to connect to a service and low ratings of the service.

The mobility of users of media devices may present further problems. When users of media devices travel for example by car, they may move away from the coverage area of the broadcast stream they are receiving. As the reception of the media stream becomes weak, the user may manually tune to a broadcast station transmitting the same stream using a different frequency. However, the associating data of the associated service may become outdated as the frequency used in the transmission of the media stream is changed. Thus, the user must also update the associating data. These procedures may be cumbersome to the user.

### BRIEF DESCRIPTION OF THE INVENTION

An object of the invention is to provide an improved solution for updating associating data in a media device. According to an aspect of the invention, there is provided a method of updating associating data in a media device, the associating data relating to a service being transmitted over a radio interface of a cellular telecommunication system and associating the service with a broadcast media stream transmitted by a broadcast system, the method comprising: determining a starting point of a route of the media device; determining a geographical route from the starting point to a point of destination, the route comprising a set of locations between and including the starting point and the destination; receiving a selection of a location from the set of locations; determining the associating data related to the service and a broadcast media stream transmitted to the geographical area in the vicinity of the selected location; receiving the broadcast media stream and the service associated with the media stream.

According to another aspect of the invention, there is provided a media device configured to: communicate with a cellular telecommunication system; receive a broadcast media stream from a broadcast system; determine a starting point of a route of the media device; determine a geographical route from the starting point to a point of destination, the route comprising a set of locations between and including the starting point and the destination; receive a selection of a location from the set of locations; determine associating data relating to a service being transmitted over a radio interface of a cellular telecommunication system and associating the service with the broadcast media stream transmitted by a broadcast system in the vicinity of the selected location; receive the broadcast media stream and the service associated with the media stream.

According to yet another aspect of the invention, there is provided a media device comprising: means for communicating with a cellular telecommunication system; means for receiving a broadcast media stream from a broadcast system; means for determining a starting point of a route of the media device; means for determining a geographical route from the starting point to a point of destination, the route comprising a set of locations between and including the starting point and the destination; means for receiving a selection of a location from the set of locations; means for determining associating data relating to a service being transmitted over a radio interface of a cellular telecommunication system and associating the service with the broadcast media stream transmitted by a broadcast system in the vicinity of the selected location; and means for receiving the broadcast media stream and the service associated with the media stream.

According to another aspect of the invention, there is provided a computer program product encoding a computer program of instructions for executing a computer process for updating associating data in a media device, the associating data relating to a service being transmitted over a radio interface of a cellular telecommunication system and associating the service with a broadcast media stream transmitted by a broadcast system, the process comprising: determining a starting point of a route of the media device; determining a geographical route from the starting point to a point of destination, the route comprising a set of locations between and including the starting point and the destination; receiving a selection of a location from the set of locations; determining the associating data related to the service and a broadcast media stream transmitted to the geographical area in the vicinity of the selected location; receiving the broadcast media stream and the service associated with the media stream.

According to another aspect of the invention, there is provided a computer program distribution medium readable by a computer and encoding a computer program of instructions for executing a computer process for updating associating data in a media device, the associating data relating to a service being transmitted over a radio interface of a cellular telecommunication system and associating the service with a broadcast media stream transmitted by a broadcast system, the process comprising: determining a starting point of a route of the media device; determining a geographical route from the starting point to a point of destination, the route comprising a set of locations between and including the starting point and the destination; receiving a selection of a location from the set of locations; determining the associating data related to the service and a broadcast media stream transmitted to the geographical area in the vicinity of the selected location; receiving the broadcast media stream and the service associated with the media stream.

The embodiments of the invention provide several advantages. The proposed solution makes it easy for the user of a media device to keep a broadcast media stream and a service associated with the media stream in synchronization with each other even when on the road. The solution presents a novel way of storing the route of the media device in the memory of the media device and a quick way of updating the associating data which is required when receiving a service associated with a broadcast stream transmission.

### LIST OF DRAWINGS

In the following, the invention will be described in greater detail with reference to the embodiments and the accompanying drawings, in which

FIG. 1 illustrates an example of a system in which embodiments of the invention may be utilized;

FIG. 2 illustrates an example of a media device;

FIG. 3 illustrates an example of a media device traveling through coverage areas of several broadcast transmitters;

FIGS. 4A, 4B, 4C illustrates examples of how to define a route of a media device;

FIGS. 5A and 5B illustrate other embodiments of invention.

### DESCRIPTION OF EMBODIMENTS

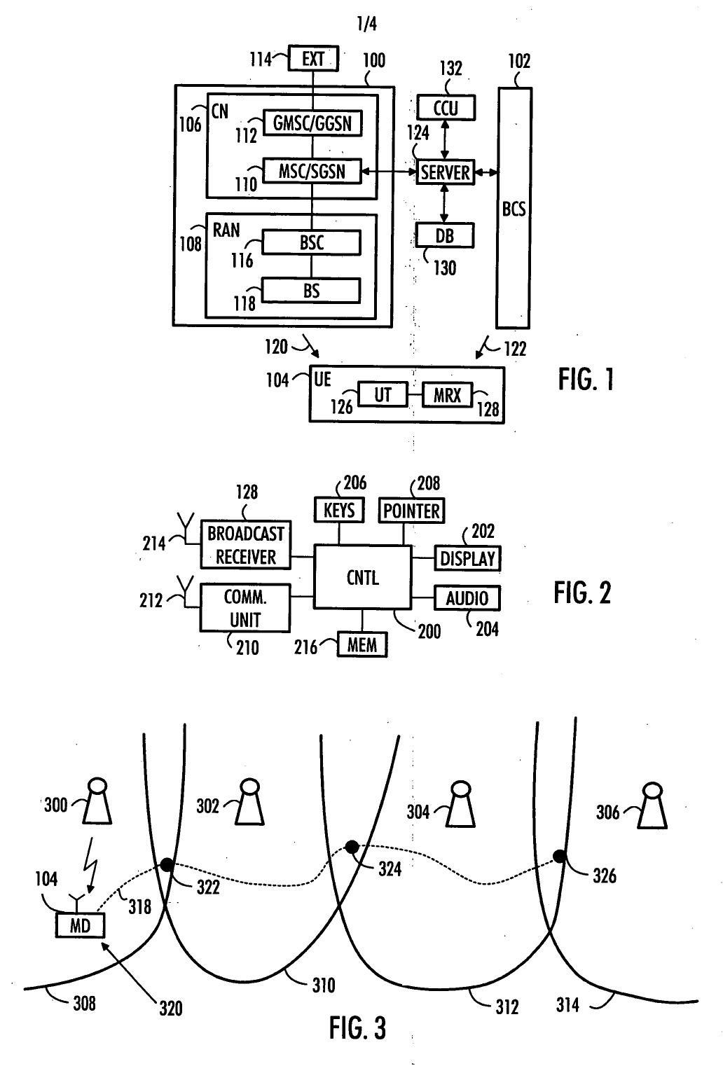

FIG. 1 illustrates an example of a simplified structure of a system in which embodiments of the invention may be utilized. The system comprises a communication network 100 of a cellular telecommunications system, a broadcast system 102, and a media device 104 of the cellular telecommunications system.

The cellular telecommunications system is based on, for example, a GSM (Global System for Mobile Communications) or UMTS (Universal Mobile Telecommunications System). The radio interface used in the communication between the communication network and the media device may be realised using WCDMA (Wideband Code Division Multiple Access) technology, GPRS (General Packet Radio Service) or WLAN (Wireless Local Area Network), or any other similar services offering the solution. The structure and functions of cellular telecommunications systems are known to a person skilled in the art, and not all network elements of the system are illustrated.

The communication network 100 provides the media device 104 with bi-directional communication services. The broadcast system 102 provides the media device 104 with a media stream 122 using, for example, a radio or television broadcast.

The communication network 100 may represent the fixed infrastructure of the cellular telecommunication system. The communication network 100 may comprise a core network (CN) 106 representing a radio-independent layer of the communication network 100, and at least one radio access network (RAN) 108. The core network 106 may include network elements of different generations of cellular telecommunications systems. The radio access network 108 provides the media device 104 with radio interface using a radio access technology. The media device thus has a bi-directional radio connection 120 with the radio access network 108.

In the example shown in FIG. 1, the core network 106 is exemplified in terms of GSM terminology using both circuit-switched and packet-switched network elements. The packet-switched network elements are described in terms of a GPRS (General Packet Radio Service) system, which provides the media device 104 with access to external data networks over GSM and supports standard protocols, such as TCP (Transmission Control Protocol) and IP (Internet Protocol). The invention is not, however, restricted to the systems, division of systems, or protocols used in the system described in the examples, but can be applied to any cellular telecommunications system.

A center 110 represents a mobile services switching center (MSC) and a serving GPRS support node (SGSN) enabling circuit-switched and packet-switched signaling, respectively, in the cellular telecommunications system.

A function of the serving GPRS support node is to transmit packets to and receive them from the media device 104 supporting packet-switched transmission. The serving GPRS support node includes subscriber information and location information about the media device 104.

The core network 106 may also have a gateway unit 112 representing both a gateway mobile service switching center (GMSC) and a gateway GPRS support node (GGSN). The GMSC attends to the circuit-switched connections between the core network 106 and external networks (EXT) 114, such as a public land mobile network (PLMN) or a public switched telephone network (PSTN), and the GGSN attends to the packet-switched connections between the core network 106 and external networks 114, such as the Internet.

The center 110 controls the radio access network 108, which may comprise at least one base station controller (BSC) 116 controlling at least one base station (BS) 118. The base station controller 116 may also be called a radio network controller, and the base station 118 may be called a node B.

The system of FIG. 1 further comprises a server 124 connected to the communication network 100 and the broadcast system 102 for providing the media device 104 with a service associated with the media stream 122 by using the radio interface of the cellular telecommunication system. The server 124 may be a computer, such as a personal computer or a workstation with an interface to the communication network 100 and the broadcast system 102. The physical location of the server 124 is not relevant as far as required connections exist.

The server 124 may be connected to the center 110, the gateway unit 112, the radio access network 106, or other parts of the communication network 100. The server 124 may be connected to the communication network 100 via an external network 114. In an embodiment, the server 124 communicates with the communication network 100 over the radio interface of the cellular telecommunication system.

The media device 104 comprises a user terminal 126 for communicating in the cellular telecommunication system using a radio interface provided by the base station 118. The media device 104 further comprises a media receiver 128, such as an FM receiver or a television receiver, for receiving a media stream 122 provided by the broadcast system 102.

The base station 118 may communicate with the media device 104 using GPRS, in which data is transferred in packets that contain address and control data in addition to the actual content data. Several connections may employ the same transmission channel simultaneously. This kind of packet switching method is suitable for data transmission where the data to be transmitted is generated in bursts. In such a case, it is not necessary to allocate a data link for the entire duration of transmission but only for the time it takes to transmit the packets. This reduces costs and saves capacity considerably during both the set-up and the use of the communication network 100.

The server 124, for example, controls the content flow between the media device 104 and the communication network 100. The server 124 may also facilitate timed delivery of content of the service to the media device 104.

The media stream 122 is broadcasted by the broadcast system 102. The media stream 122 may include, for example, a radio or television program, a commercial or an announcement. The media stream 122 may include speech, music, or pictures. The content of the media stream 122, however, is not relevant to the present solution. The media device is configured to receive the broadcasted media stream 122 with the media receiver 128.

The media device may be provided with a service which is associated and/or synchronized with the broadcasted media stream 122 transmitted by the broadcast system. The service may provide the user of the media device with visual information related to the content of the broadcast media stream 122. The service may be interactive. The service may include information about the music played at the moment, a timetable of the program, DJ's messages to the listeners or the like. The signal may include any of these features alone or as a combination thereof. The service may include information about deliverable or purchasable objects related to the media stream, such as ring tones, desktop wallpapers or logos.

The service may be provided to the media device 104 utilizing a communication channel parallel to the broadcast channel used in delivering the media stream 122 to the user. This is called a parallel channel operation. A logical address may be dedicated to the service 120 so that the service 120 may be accessed by using the logical address of a database 130 of the server 112. The database 130 of the service comprises computer files containing the service content. The content of the service may vary as a function of time and possibly as a function of the content of the media stream 122. The service 120 provides a bit stream to the media device 104, the bit stream including information content, such as graphical information, text information, audio information, a computer program, Braille, vibration, or any combination thereof. In an embodiment, the content of the service 120 is displayed on a display of the media device 104.

When the parallel channel software operation in the media device 104 is initiated, the media device may subscribe to the service by transmitting information about itself to the server 124. After receiving the subscription, the server 124 starts transmitting the service to the media device 104. With the information about the media device 104, a specific variant of the content of the service can be delivered, which contains graphics objects optimized to the capabilities and the screen size of each media device 104.

A service provider is a party possessing rights for relevant digital content of the service 120, a distribution system for providing the media device 104 with the service 120, and possibly the capability to bill the user for the service 120. The service provider's delivery system is responsible for receiving and handling delivery requests and delivering the service 120 to the media device 104.

In the media device 104, the solution provides an integrated user experience, allowing the user to start both listening to a media stream 122 and receiving the content of the service relating to the media stream 122. The operation of the media is based on two channels, the broadcast channel and the parallel channel enabled by the cellular telecommunication system.

In an embodiment, the service concept may be called a visual radio. The broadcast system broadcasts a radio transmission 122 received by the media device 104. The DJ or announcer of the radio transmission may advertise the service realized with the parallel channel. The user of the media device may subscribe to the service by making contact with the server and downloading suitable data which enables the user's media device to receive the service. The data may be called associating data and it may comprise information which provides a linkage between the service and the media stream and which identifies the service transmission.

The associating data may include the following type of information: a radio service address, a service identification, an object identification, a radio broadcaster identification number, a program identification number, a traffic announcement identification number, a traffic program identification number, a program item number, an emergency warning message, a music/speech indicator, a radio frequency utilized by a media stream, a program service name, a program type identification number, and a country code.

Typically but not necessarily, a service is associated with a given media stream. Each media stream may have a distinct service associated and/or synchronized with it. In solutions of prior art, a user has to download associating data for each media stream separately. In a given area there may be several media broadcasters which broadcast their own media stream. For example, transmissions of several radio stations may be received in the same area. Several radio stations may provide their users with a service realized with a parallel channel.

With reference to FIG. 2, examine an example of a media device in which embodiments of the invention can be applied. The media device comprises controller 200, typically implemented with a microprocessor, a signal processor or separate components and associated software. The device further comprises a display 202. The display is typically configured to display graphics and text. The device may also comprise an audio interface 204, which may be realized with a speaker or headset and a microphone, for example. The device may further comprise a keypad 206 and a pointer device 208, such as a mouse, a track stick or a touch-pad. Depending on the type of the device, there may be different and a different number of user interface parts.

The media device also comprises a communication unit 210 implementing the functions of terminal equipment including speech and channel coders, modulators and RF parts. The device may also comprise an antenna 212 connected to the communication unit. The device may also comprise a broadcast receiver 128 configured to receive broadcast transmissions sent by a broadcast system. The receiver 128 is a radio or television receiver, for example. The device may also comprise an antenna 214 connected to the broadcast receiver 128. The device may also comprise a single antenna connected to both the communication unit 210 and the broadcast receiver 128. The device also typically comprises a memory 216 for storing e.g. telephone numbers, communication parameters, broadcast receiver parameters, calendar data and other user-specific data.

The media device is not restricted to the above example. The media device may be a personal computer, a personal digital assistant, terminal equipment or any other device comprising required communication facilities.

The same media stream, such as a radio transmission, may be transmitted over a large geographical area. Several transmitters may be utilized to cover the desired area. FIG. 3 illustrates an example of a media device 104 traveling through coverage areas of several broadcast transmitters. The route 318 of the media device 104 is shown in FIG. 3 as a dashed line. FIG. 3 shows three transmitters 300, 302, 304 and 306 which transmit a given media stream. Each transmitter 300 to 306 has a coverage area 308, 310, 312 and 314, correspondingly. Typically, the frequencies used by adjacent transmitters differ from each other so that interference between transmitters may be minimized.

As each transmitter is transmitting the same media stream, the service associated with the transmission may be the same, but it may also be different. For example, the service may comprise localized information, such as weather information or advertisements. However, as the frequency with is used to transmit the media stream is different, also the associating data associating a service with the media stream is different for each transmission. The service is transmitted to the media device 104 via a cellular telecommunication system. Cells of the telecommunication system are not displayed in FIG. 3 for clarity reasons. It can be assumed that the media device is all the time in the coverage area of the telecommunication system, and may perform handovers from cell to cell as it travels along the route 318. The realization of the connection of the media device to the telecommunication system is known for one skilled in the art.

In many cases the user of the media device knows the route he/she is traveling in advance. This knowledge may be utilized to make the updating and tuning of the media device to different transmissions more flexible to the user. The media device may be configured to receive and store information about the route. This information may be used in switching from one transmission to another or from one service to another.

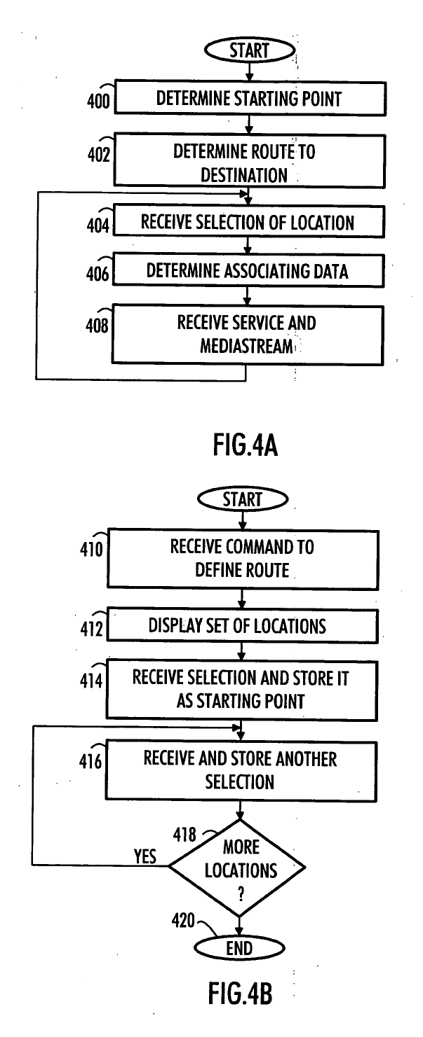

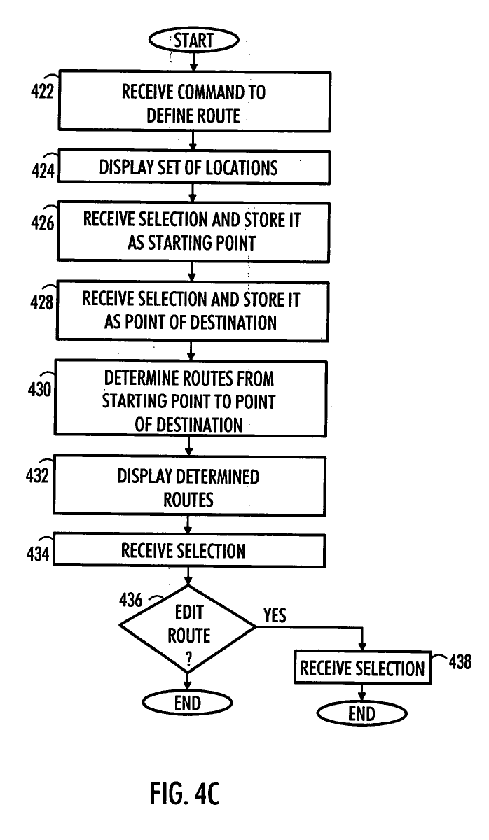

FIG. 4A illustrates an embodiment of the invention with a flowchart. In step 400, a starting point 320 of a route of the media device is determined.

In step 402, a geographical route from the starting point to a point of destination is determined. The route comprises a set of locations between and including the starting point and the destination. In this example, the route may comprise the locations 320, 322, 324 and the destination 326. The locations may be defined with different accuracy, depending on the case or route. FIG. 3 shows locations as small points, but in another embodiment the location may be defined as a city, for example. The accuracy of location determination may depend upon the coverage areas of the transmitters 300 to 306. In an embodiment, the locations are in relation to the coverage areas.

In step 404, the user of the media device has begun traveling with the media device. The media device receives a selection of a location from the set of locations of the route. The first selection may be the starting point 320, for example.

In step 406, the media device determines the associating data related to the service and a broadcast media stream transmitted to the geographical area in the vicinity of the selected location. With the associating data, the media device may be configured to correctly receive both the media stream and the service associated with the stream.

In step 408, the media device receives the broadcast media stream and the service associated with the media stream. Next, as the user travels along the route with the media device, the procedure may continue from 404. The next point to be selected may be point 322.

The determination and storing of the route may be performed in various ways. FIG. 4B illustrates an embodiment where the route is defined manually. The media device 104 stores a list of geographical locations in a memory of the device. The list may comprise a set of towns, villages or localities in a given area or country. The media device may comprise several lists of different areas, and the user may select which list is to be used each time. The list may also comprise relations of the locations with each other. The list may comprise information which locations are adjacent to each other and possible connections between locations.

In an embodiment, the list of locations is stored in the cellular telecommunications network and loaded into the media device on demand.

In step 410, the media device receives a command to define a route.

In step 412, the media device loads the list of locations stored in the memory and displays the list on the display of the media device.

In step 414, the media device receives a selection of a location, stores the location as the starting point of a route of the device and displays the list on the display again.

In step 416, the media device receives another selection of a location and stores the location as the next location on a geographical route.

In step 418, the media device checks whether a command to end the route definition is received. If this is not the case, the process continues from step 416. Otherwise the route is completed. The last location is assumed to be the point of destination. The process ends in 420.

In an embodiment, when displaying the list of locations, the displayed list is limited to neighboring locations of the previous selection. This may ease the selection process as there are fewer locations to choose from.

FIG. 4C illustrates an embodiment where the route is defined semi automatically. In step 422, the media device receives a command to define a route.

In step 424, the media device loads the list of locations stored in the memory and displays the list on the display of the media device.

In step 426, the media device receives a selection of a location, stores the location as the starting point of a route of the device and displays the list on the display again.

In step 428, the media device receives a selection of a location and stores the location as the point of destination.

In step 430, the media device determines a list of possible routes from the starting point to the point of destination from a list of locations and connections of these locations.

In step 432, the media device displays the list of possible routes on a display of the media device.

In step 434, the media device receives a selection of a route.

In step 436, the media device queries if the user wishes to edit the selected route manually. If this is the case, the media device presents the user the route and receives possible changes in step 438.

Otherwise, the process ends.

In an embodiment, the semiautomatic process described above is performed partly in a server of the telecommunications system. The media device may transmit information about the starting point and the point of destination to the server, which determines possible routes between the locations, and transmits information about the routes back to the media device.

A previously defined and stored route may be loaded from the memory and edited. A route may also be inverted, i.e. it may be traveled in opposite direction.

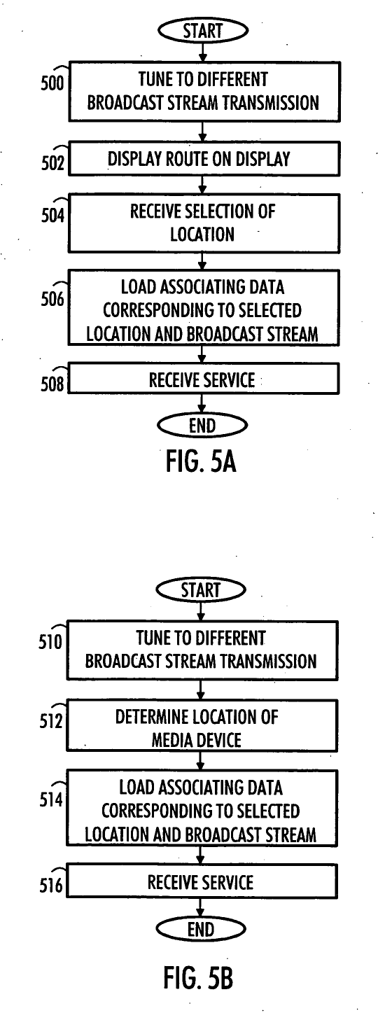

FIG. 5A illustrates an embodiment of the invention with a flowchart. FIG. 5A relates to updating associating data while a media device is traveling. In step 500, a media device tunes to a transmission of a new broadcast stream transmitter. The situation may be that the media device is traveling along the route illustrated in FIG. 3, is leaving the coverage area of transmitter 300 and arriving in the coverage area of transmitter 302. The media device was receiving a stream transmitted by transmitter 300 on a given frequency. The transmitter 302 is transmitting the same stream but using a different frequency. The media device tunes to the frequency used by the transmitter 302 either automatically or under manual control of the user.

In step 502, the media device displays a predefined route on the display of the device. The route may be displayed automatically as a result of the tuning of the broadcast receiver of the media device, or it may be displayed as a response to a command given by the user. The route to be displayed may be a predefined route or the user may be given a choice to select a route to be displayed from a set of routes currently stored in the device.

The displayed route comprises a set of locations between and including the starting point and the point of destination. In this example, the route comprises location points 320, 322, 324 and 326. The list is displayed so that the user may easily select the current geographical location of the media device. In step 504, the media device receives a selection of a location. In this example, the location may be point 322.

In step 506, the media device loads associating data corresponding to the selected location and the broadcast media stream currently being received. The associating data may already be stored in the memory of the media device, or the media device may download the associating data from a server.

In step 508, the media device configures itself with the associating data for the reception of the service associated with the received broadcast media stream and starts receiving and displaying the service.

FIG. 5B illustrates another embodiment with a flowchart. In this embodiment, the updating of the associating data is performed automatically. In step 510, a media device tunes to a transmission of a new broadcast stream transmitter in a similar manner as in step 500.

In step 512, the media device determines the geographical location of the media device. This may be realized with a satellite positioning system receiver, such as a GPS (Global Positioning System) receiver. The media device may comprise a GPS receiver with which the location of the device may be determined automatically. The determined location may be compared with a location in the stored set of locations belonging to the predefined route; and if a match was found with a given accuracy, a location is selected from the list. This procedure allows adjustment between the accuracy of the GPS receiver and the accuracy used in the set of the locations.

The location may also be determined with the aid of information received from the cellular telecommunication system. The media device may send a location request to the system. For example, the system may determine the location of the media device with the accuracy of a base station coverage area. As the coverage areas of base stations are usually smaller than coverage areas of broadcast media transmitters, the accuracy of the location determination is sufficient. The system may also use more sophisticated positioning methods for determining the location of the media device. These methods are known in the art. The system may send information about the location of the media device to the media device.

In step 514, the media device loads associating data corresponding to the selected location and the broadcast media stream currently being received.

In step 516, the media device configures itself with the associating data for the reception of the service associated with the received broadcast media stream and starts receiving and displaying the service.

Embodiments of the invention may be realized with a software product encoding a computer program of instructions for executing a computer process for updating associating data in a media device. The software may be loaded into the controller 200 of the media device. The software may be stored in memory 216 of the media device. The controller may execute the instructions defined in the software and control the operation of the media device accordingly.

Even though the invention is described above with reference to an example according to the accompanying drawings, it is clear that the invention is not restricted thereto but it can be modified in several ways within the scope of the appended claims.

1. A method of updating associating data in a media device, the associating data relating to a service being transmitted over a radio interface of a cellular telecommunication system and associating the service with a broadcast media stream transmitted by a broadcast system, the method comprising:
determining a starting point of a route of the media device;
determining a geographical route from the starting point to a point of destination, the route comprising a set of locations between and including the starting point and the destination;
receiving a selection of a location from the set of locations;
determining the associating data related to the service and a broadcast media stream transmitted to the geographical area in the vicinity of the selected location;
receiving the broadcast media stream and the service associated with the media stream.

2. The method of claim 1, further comprising:
storing a list of locations in a memory of the media device;
displaying the list of locations on the display of the media device;
receiving a selection of a location and storing the location as the starting point of a route of the device;
receiving another selection of a location and storing the location as the next location on a geographical route;
repeating the previous step until a command to store the route is received.

3. The method of claim 2, further comprising:
limiting the displayed list of locations to neighboring locations of the previous selection.

4. The method of claim 1, wherein receiving a selection of a location from the set of locations comprises:
determining the location of the media device;
comparing the determined location with a location in the stored set of locations; and if a match was found, selecting a location for the set.

5. The method of claim 4, further comprising:
determining the location of the media device using a satellite positioning system.

6. The method of claim 4, further comprising:
determining the location of the media device using information received from the cellular telecommunication system.

7. The method of claim 1, wherein receiving a selection of a location from the set of locations comprises:
displaying the set of locations on a display of the media device;
receiving a selection of a location from the displayed set of locations.

8. The method of claim 1, wherein the determining a geographical route comprises:
determining a point of destination;
determining a list of possible routes from the starting point to the point of destination from a list of locations and connections of these locations;
displaying the list of possible routes on a display of the media device;
receiving a selection of a route.

9. The method of claim 8, further comprising:
storing a list of locations and connections of these locations in a memory of the media device.

10. The method of claim 8, further comprising:
storing a list of locations and connections of these locations in a server connected to the cellular telecommunications network.

11. A media device configured to:
communicate with a cellular telecommunication system;
receive a broadcast media stream from a broadcast system;
determine a starting point of a route of the media device;
determine a geographical route from the starting point to a point of destination, the route comprising a set of locations between and including the starting point and the destination;
receive a selection of a location from the set of locations;
determine associating data relating to a service being transmitted over a radio interface of a cellular telecommunication system and associating the service with the broadcast media stream transmitted by a broadcast system in the vicinity of the selected location;
receive the broadcast media stream and the service associated with the media stream.

12. The media device of claim 11, further comprising:
a memory for storing a list of locations;
a display for displaying the list of locations;
a processor configured to
receive a selection of a location,
store the location in the memory as the starting point of a route of the device;
receive another selection of a location and storing the location as the next location on a geographical route; and to
repeat the previous step until a command to store the route is received.

13. The media device of claim 11, wherein the processor is configured to limit the displayed list of locations to neighboring locations of the previous selection.

14. The media device of claim 11, wherein the media device is configured to determine the location of the media device;
compare the determined location with a location in the stored set of locations; and if a match was found, selecting a location for the set.

15. The media device of claim 14, wherein the media device comprises a satellite positioning system receiver for determining the location of the media device.

16. The media device of claim 14, further comprising:
the media device is configured to determine the location of the media device using information received from the cellular telecommunication system.

17. A media device comprising:
means for communicating with a cellular telecommunication system;
means for receiving a broadcast media stream from a broadcast system;
means for determining a starting point of a route of the media device;
means for determining a geographical route from the starting point to a point of destination, the route comprising a set of locations between and including the starting point and the destination;
means for receiving a selection of a location from the set of locations;
means for determining associating data relating to a service being transmitted over a radio interface of a cellular telecommunication system and associating the service with the broadcast media stream transmitted by a broadcast system in the vicinity of the selected location; and
means for receiving the broadcast media stream and the service associated with the media stream.

18. A computer program product encoding a computer program of instructions for executing a computer process for updating associating data in a media device, the associating data relating to a service being transmitted over a radio interface of a cellular telecommunication system and associating the service with a broadcast media stream transmitted by a broadcast system, the process comprising:
determining a starting point of a route of the media device;
determining a geographical route from the starting point to a point of destination, the route comprising a set of locations between and including the starting point and the destination;
receiving a selection of a location from the set of locations;
determining the associating data related to the service and a broadcast media stream transmitted to the geographical area in the vicinity of the selected location;
receiving the broadcast media stream and the service associated with the media stream.

19. A computer program distribution medium readable by a computer and encoding a computer program of instructions for executing a computer process for updating associating data in a media device, the associating data relating to a service being transmitted over a radio interface of a cellular telecommunication system and associating the service with a broadcast media stream transmitted by a broadcast system, the process comprising: determining a starting point of a route of the media device;
determining a geographical route from the starting point to a point of destination, the route comprising a set of locations between and including the starting point and the destination;
receiving a selection of a location from the set of locations;
determining the associating data related to the service and a broadcast media stream transmitted to the geographical area in the vicinity of the selected location;
receiving the broadcast media stream and the service associated with the media stream.

20. The computer program distribution medium of claim 19, the distribution medium comprising a computer readable medium, a program storage medium, a record medium, a computer readable memory, a computer readable software distribution package, a computer readable signal, a computer readable telecommunications signal, and a computer readable compressed software package.
